(19) United States
(12) Patent Application Publication
(10) Pub. No.: US 2003/0190281 A1
(43) Pub. Date: Oct. 9, 2003

(54) Aluminium hydroxide gel

(76) Inventors: Gerhard Kudermann, Alfter (DE); Jurgen Schubert, Grafschaft (DE)

Correspondence Address: FISH & NEAVE, 1251 AVENUE OF THE AMERICAS, 50TH FLOOR, NEW YORK, NY, 10020-1105, US

(21) Appl. No.: 10/220,620

(22) PCT Filed: Feb. 28, 2001
(86) PCT No.: PCT/EP01/02205

(30) Foreign Application Priority Data
Feb. 29, 2000 (DE) 100 09 369.8

(51) Int. Cl. C01F 7/02

(52) U.S. Cl. 423/629

(57) ABSTRACT

The invention relates to a method for producing a stable aluminium hydroxide gel on the basis of the sodium aluminate lye which is obtained during the production of Al₂O₃ according to the BAYER method. The caustic mol ratio (Na₂O_{free}/Al₂O₃) of the lye containing aluminate is adjusted to smaller than 1.6. The lye is treated with carboxylic acid anhydride, whereby the aluminium hydroxide gel is precipitated at a temperature of below approximately 40° C., whereby the pH value ranges from 8 to 12. The precipitation product and the lye are separated from one another. The precipitation product is washed and dried, whereby the amorphous structure is obtained.

The invention relates to a method for producing an aluminium hydroxide gel, which can be carried out in a bypass flow to a BAYER method for obtaining aluminium oxide from bauxite.

Aluminium hydroxide is used as caustic in the textile industry, as a constituent of antihydrotica, dental cleaning powder, paper-making, ceramics, abrasives, as antacid, as filler and pigment in the plastics and rubber industry as well as in cosmetics, for fireproofing of carpets and synthetics and as adjuvant in vaccines. Since recently aluminium hydroxide gels have been used for producing polyaluminium sulfate for use as setting accelerators in concrete. The aim here is to put the greatest possible proportion of aluminium into the setting accelerator.

Soluble and insoluble aluminium hydroxide are to be differentiated. Insoluble aluminium hydroxide is in crystalline form and is obtained for example from the Bayer lye by addition of vaccine crystals and agglomeration from oversaturated Bayer lye. A typical agent of crystalline aluminium hydroxide is hydrargillite. Aluminium hydroxide gel is a soluble aluminium hydroxide and is rontgen-amorphous.

DE 854 946 describes the production of a reaction-capable aluminium hydroxide or a reversibly colloidal aluminium hydroxide and considers that after precipitation of the aluminium hydroxide it is essential to remove the precipitate as quickly as possible from the harmful effect of alkaline reacting alkali compounds, since these cause the aluminium hydroxide to age. The caustic mol ratio (Na₂O_{free}/Al₂O₃) during precipitation is 0.75. The known method also provides for the aluminium hydroxide to be dried after washing at a temperature of 110° C.

It is known from GB 1 272 715 to produce aluminium hydroxide gels by adding an aluminium chloride solution or aluminium sulfate solution to a solution of sodium carbonate and/or sodium bicarbonate while stirring at a temperature of approximately 30° C. Precipitation from an acid solution therefore takes place. The precipitate is filtered and washed until it is as free as possible of soluble salts. Depending on the starting material and the precipitation conditions the quality and the physicochemical properties of the aluminium hydroxide gel can vary. The disadvantage to the method described is that it utilises a relatively expensive starting material, generally manufactured form aluminium nitrate or sodium aluminate.

FR 2 255 080 proposes a method for obtaining dried aluminium hydroxide gel, based on the aluminate lye occurring during production of aluminium oxide or on the aluminate lye obtained with soda during treatment of technical aluminium oxide hydrate. In this method carboxylic acid anhydride is supplied to the lye containing the aluminate with a caustic ratio of 1.6 to 1.8 over a period of 20 to 40 minutes at a temperature of 20 to 30° C. and at a pressure of 1 to 2.5 atmospheres, the resulting precipitate is filtered, washed until neutral, placed in suspension with water and the suspension is then acidified with a mineral acid. Finally, it is again filtered, washed and dried. The filtrate contains less than 0.2 g/l of dissolved Al₂O₃. This method is used to obtain qualitatively high-value aluminium hydroxide gels, especially with respect to the acid-binding capability, nevertheless it is very costly to treat aluminium hydroxide gel after separation from the precipitation lye using the additional acid treatment process, inter alia for reducing the adhering Na₂O. Also, an additional cycle for recovery of the mineral acid is required, otherwise disposal problems occur for the salt solution resulting from treatment with mineral acid. The salt solution or salt residues originating from neutralisation remain for obtaining mineral acid.

The object of the invention therefore is to design the method known from FR 2 255 080 more economically, whereby the product quality should at least be maintained and an aluminium hydroxide gel with high long-term stability especially should be provided. In particular, the aim is to provide a gel whose solubility is as high as possible and which remains intact for as long as possible. High solubility is important for production of aluminium sulfate solutions with over-stoichiometric aluminium content, which are used as setting accelerators for concrete in the building industry, for the production of aluminium chloride solutions with over-stoichiometric aluminium content (basic aluminium chloride), which are used for water purification, in the paper industry, for the production of aluminium oxide fibres and for deodorants, and for direct production of aluminium formiate from aluminium hydroxide and formic acid, as used in the leather industry.

This problem is solved by a method for producing aluminium hydroxide gel, in which the aluminate lye obtained during production of Al₂O₃ according to the BAYER method is diluted with water as required to set a suitable mol ratio (MR Na₂O_{free}/Al₂O₃) and a suitable Al₂O₃ concentration, treated at a temperature of less than approximately 40° C., preferably less than about 30° C., at a pH value of 8 to 12 with carbon dioxide under precipitation of aluminium hydroxide gel; the precipitate is separated from the precipitation lye, and the precipitate is washed and dried. The aluminium hydroxide obtained according to the present invention is roentgen-amorphous, has a high solubility over a long period and also has an acid-binding capacity.

The method of the present invention differs from the method in FR 2 255 080 in that the treatment of the precipitated aluminium hydroxide with a mineral acid and thus also an additional washing step are omitted. This acid treatment is described by FR 2 255 080, but as an essential component of the method, because the desired neutrality of the aluminium hydroxide gel is achieved while preserving the acid binding capability.

An advantage of the method according to the present invention is that it can be performed in close association with the BAYER method for producing aluminium oxide, whereby a sodium aluminate lye occurring in the BAYER method is used not only as starting material, but the by-products accumulating during production of aluminium hydroxide gel after causticizing can be recycled to the BAYER method. Causticizing is understood to mean recovery of the alkali bound as sodium carbonate by conversion with calcium hydroxide.

The starting material in the method according to the present invention is a product flow from the BAYER process, in which sodium aluminate or aluminium hydroxide and, after its calcination, aluminium oxide is obtained from bauxite via treatment with sodium lye in an autoclave. This method is described in Ullmanns Encyclopaedia of Technical Chemistry, 3rd edition, 3rd volume, pages 375 to 391, the disclosure of which is referred to for the purpose of describing this invention. The starting material is an aluminate lye obtained after separation of the red sludge, which preferably also undergoes subsequent filtration to release the lye from the last suspended red sludge particles, or is removed at another point in the lye cycle, for example after separation of the crystallised and agglomerated aluminium hydroxide (hydrargillite). The concentration of the Al₂O₃ dissolved in the lye can be 10 to 90 g/l, for example, preferably more than 30 g/l. The caustic mol ratio (Na₂O_{free}/Al₂O₃) of the lye containing the aluminate, which is to be precipitated from the aluminium hydroxide, is less than 1.6, preferably 1 to less than 1.6.

This lye is treated with carboxylic acid anhydride, whereby the aluminium hydroxide is precipitated. The method is preferably carried out with precipitation beginning at a pH value of approximately 12, and more than 96% of the aluminium is precipitated when a pH value of 11 in the reaction mixture is reached. In terms of additional yield introducing CO₂ is uneconomical below a pH value of 11.

It was established that due to unconverted carbon dioxide, especially from a pH value of less than 11, the formation of sodium bicarbonate is favoured. This is a disadvantage because sodium is bound in the product and the long-term stability of the aluminium hydroxide gel deteriorates. Sodium is, however, very difficult to wash out.

It has proven particularly beneficial that the bauxite used for hydrolysis has a content of organically bound carbon (OC) of =0.05 mass %. These are tropical forms of bauxite, whose OC is broken down under reaction conditions in the BAYER method into high-molecular and low-molecular humic acid constituents and further into aliphatic carbonic acid esters such as acetates, oxalates and further still into carbonates. Hydrogen is released from these organic products during bauxite hydrolysis (reducing conditions). In addition, oxidation-reduction reactions occur among the humic acid constituents. The decomposition products are present in the lye as dissolved sodium salts.

It was observed that the amorphous structure of the precipitated aluminium hydroxide gel is stabilised particularly well if the aluminium hydroxide gel is precipitated from a lye which was treated with oxygen shortly before.

To further stabilise the amorphous structure of the precipitated aluminium hydroxide gel stabilisers such as carbohydrates and aldites can be added to the precipitation lye. Saccharides are an example of suitable carbohydrates. Examples of suitable aldites are glycerine, sorbitol and other sugar alcohols. These stabilisers are used according to preferred duration of stability and can be added in small quantities. Yet it was surprising that these means for the gel obtained by the inventive method are not required.

The precipitated aluminium hydroxide gel is then separated from the precipitation lye. Separation can be carried out by filtering, decanting or centrifuging. The separated aluminium hydroxide gel is washed with water. The gel is then dried, at which point temperature and dwell time are set such that there is no premature crystallisation of the aluminium hydroxide gel, which might harm the solubility behaviour of the gel. The gel itself should not be heated over 40° C., preferably only to 30° C. approximately.

Dissolved sodium carbonate inter alia forms with precipitation of the aluminium hydroxide gel by treating the lye containing aluminate with carboxylic acid anhydride. After the aluminium hydroxide gel is separated so-called causticizing takes place, during which burnt lime (CaO) is added to the lye released from the gel. The causticizing step already required for a BAYER unit can be used for causticizing. Sodium hydroxide solution (sodium hydroxide lye) is recovered from the sodium carbonate solution by way of causticizing. The lye is recycled to the BAYER cycle. The calcium carbonate obtained from causticizing can be burnt and reused for causticizing or in the building materials industry. In the method according to the present invention no waste materials occur; rather, a closed circuit is provided.

FIG. 1 illustrates an exemplary embodiment of the method according to the present invention, from which the link to the BAYER method is also made.

The method can be carried out in conventional precipitation reactors. Carbon dioxide can be admitted for example via a perforated disc in the base of the reactor or via a perforated tube arranged annularly on the edge in the lower section of the reactor. The precipitation reactor can be in the form of a kettle or a tube reactor. It has proven advantageous to equip the reactor with a paddle agitator to bring carbon dioxide to a reaction as far as possible in the lower section of the reactor. The reactor must be cooled to keep the temperature in the reaction mixture below 40° C., preferably below 30° C.

According to another preferred embodiment of the invention neutralisation of the BAYER lye and precipitation of aluminium hydroxide gel take place in a so-called loop reactor. Such reactors are known. In the process CO₂ is supplied to the lower section of the reactor, and bubbling up and coalescence into carbon dioxide bubbles is avoided by use of a paddle agitator. The mixture of carbon dioxide and aluminate lye is aspirated into the cooled tube, where the aluminium hydroxide gel is precipitated. The resulting gel is forwarded to the upper section of the reactor vessel where it is separated from the mother liquor.

According to yet another preferred embodiment of the invention the method is run continuously. The continuous technique can be carried out, such that the floating aluminium hydroxide gel (product) is constantly removed from the top of the reactor, or can be performed in two stages. The aluminate lye can first be brought to a pH value of approximately 12 with the addition of carbon dioxide and then be conveyed to a precipitation reactor. There is still no precipitation of the aluminium hydroxide gel up to a pH value of approximately 12. In this range, however, the greatest neutralisation heat occurs. More CO₂ is added to the precipitation reactor until the reaction mixture shows a pH value of approximately 11. The aluminium hydroxide gel is precipitated in the precipitation reactor when the pH range passes from 12 to 11. The advantage of this technique is that where the main neutralisation heat accumulates, there is still no product which is impaired in quality by the neutralisation heat.

The aluminium hydroxide gel is preferably separated from the mother liquor by pressure filtration. Depending on the design of the filter filtering can take place at various pressures, for example at a pressure of 3 to 4 bar. The residual water content is then less than 40% by weight, relative to the mass of the product. A product with this water content is best suited to use in a setting accelerator.

In addition, the method according to the present invention can also be operated such that carbon dioxide is introduced to the reactor with overpressure, such as 2 bar. Where CO₂ is added under pressure from a pH value of 12, the precipitation reaction was able to be decreased from 35 minutes to 15 minutes.

The aluminium hydroxide gel can be dried by circulating air or by spray drying.

The invention will now be further explained by the following examples.

### EXAMPLE 1

Six assays in batches of 8 l were run. The glass reactor was cooled using a water bath. A Bayer lye was placed in the reactor. The lye contains 131.27 g/l Na₂O_{free} (2.12 mol) und 151.62 g/l Al₂O₃ (1.49 mol). The mol ratio Na₂O_{free}/Al₂O₃ was 1.42. The lye has a temperature of approximately 53° C. and had been diluted with water (21° C.). The temperature of the mixture was approximately 27° C.

It was supplied over a period of 45 to 60 minutes CO₂ until final pH values of 11.4, 11.3, 11.2, and 11.0 were reached and the reaction mixture was stirred using a paddle agitator. Precipitation occurred at temperatures of 24 to 28° C. Immediately after the final pH value was reached the mother liquor was separated from the precipitated aluminium hydroxide gel using a laboratory filtering flask and water jet vacuum. The filter batch was washed three times with 3 litres of water. The wet yields were between 1,500 und 1,750 g. The wet product with a water content of approximately 80% was dried at 30° C. with circulating air and then comminuted to a particle size of less than 80 μm. The water content of the dry, flowing product was approximately 20% in each case.

All resulting products exhibited very good reactivity, were amorphous and had a proportion of Na₂O of less than 5% by weight, relative to the weight of the product. The product displayed the acid-bonding capacity required by the European Pharmacopoeia. At least 5 g of aluminium hydroxide gel were dissolved in 100 ml of 10% formic acid at a temperature 45 to 50° C.

### EXAMPLE 2

Comparable batches of an aluminate lye were converted with carbon dioxide under comparable conditions, as in Example 1, using a tube reactor. Carbon dioxide was supplied at the reactor base and the fresh reaction medium was aspirated from the reactor base by a pump into the tube and returned to the reactor from above. The tube was cooled with water. The products displayed the same quality as those of Example 1.

1. A method for producing an aluminium hydroxide gel, in which the aluminate lye obtained from Al₂O₃ production according to the BAYER method is treated with carboxylic acid anhydride with precipitation of the aluminium hydroxide gel, wherein the caustic mol ratio (Na₂O_{free}/Al₂O₃) of the lye containing the aluminate is adjusted to less than 1.6, precipitation is carried out at a temperature of under approximately 40° C. and at a pH value of 8 to 12, precipitate and lye are separated from one another, and the precipitate is washed and dried while preserving the amorphous structure.

2. The method as claimed in claim 1, wherein the aluminium hydroxide gel is precipitated in a pH range of approximately 12 to 11.

3. The method as claimed in claim 1 or 2, wherein an aluminium oxide content of at least 30 g/l is adjusted before the carboxylic acid anhydride is introduced in the aluminate lye.

4. The method as claimed in any one of claims 1 to 3, wherein the aluminate lye is treated before carbon dioxide is introduced with oxygen.

5. The method as claimed in any one of claims 1 to 4, wherein the method is carried out continuously.

6. The method as claimed in claim 5, wherein the method is performed in two stages and the aluminate lye is first brought to a pH value of approximately 12 by addition of carbon dioxide, the resulting reaction mixture is forwarded to a precipitation reactor and carbon dioxide is then introduced and aluminium hydroxide gel is precipitated.

7. The method as claimed in any one of claims 1 to 6, wherein the precipitate is separated from the lye via filtration under pressure.

8. The method as claimed in claim 7, wherein the resulting product, dried to a water content of less than 40%, is pulverised.

9. The method as claimed in any one of claims 1 to 8, wherein the gel is dried to a water content of approximately 20%.

10. The method as claimed in any one of claims 1 to 9, wherein the lye obtained after separation of the aluminium hydroxide gel is causticized and the causticized products are returned to the BAYER method.
